(19) United States
(12) Patent Application Publication
(10) Pub. No.: US 2008/0029713 A1
(43) Pub. Date: Feb. 7, 2008

(54) Disposable radioactive contamination control materials

(76) Inventors: Paul Lovendale, Sandwich, MA (US); Arthur Desrosiers, West Barnstable, MA (US)

Correspondence Address: GOODWIN PROCTER LLP;PATENT ADMINISTRATOR, EXCHANGE PLACE, BOSTON, MA, 02109-2881, US

(21) Appl. No.: 11/707,829

(22) Filed: Feb. 16, 2007

Related U.S. Application Data
(60) Provisional application No. 60/774,430, filed on Feb. 17, 2006.

(51) Int. Cl. G01T 1/02

(52) U.S. Cl. 250/474.1

(57) ABSTRACT

A disposable surface wipe, a removable coating, or a filter includes a sensor that detects radioactive contamination on a surface, or radioactive contamination extracted from a gas or a fluid, and provides a signal indicating the presence of such contamination. The sensor detects ionizing radiation emitted by the radioactive contamination. The signal provided by the sensor can be visible to a user of the article or obtained with an optical instrument, and the article can include a substrate that incorporates the sensor. The article can also be a cleansing article that can decontaminate a surface and provide verification that the decontamination process is complete.

### CROSS-REFERENCE TO RELATED APPLICATIONS

This application claims the benefit of and priority to U.S. Provisional Patent Application Ser. No. 60/774,430, filed on Feb. 17, 2006, the entire disclosure of which is hereby incorporated by reference herein.

### FIELD OF THE INVENTION

This invention relates generally to radioactivity sensing materials and, more particularly, to disposable materials for indicating radioactive contamination.

### BACKGROUND

The practice of radiological protection includes the use of a variety of disposal materials that are used to sample for the presence of radioactive contamination on surfaces or in gaseous or liquid fluids. These materials are also used to sample for the presence of radiations emanating from radioactive contamination within objects, to prevent the spread of radioactive contamination from surfaces, to prevent the spread of radioactive contamination onto surfaces, or to clean radioactive contamination from surfaces. Currently, these materials do not provide any indication of the presence or the efficacy of removal of radioactive contamination that is detectable by aided or unaided human vision. The current state of the art requires that the user measure contamination on the surface of the surface wipe article using a suitable radioactive surface contamination instrument, which incurs the costs associated with performing a separate action, acquiring and maintaining a radiation instrument, and performing training in the operation of the radiation instrument. This limitation increases the effort and the cost required to perform sampling surveys, to complete cleaning activities, and to conduct programs to restrict the spread of radioactive surface contamination.

Examples of radiation detection can be found in U.S. Pat. Nos. 5,053,339, 5,206,118, 5,420,000, 5,731,112, 6,524,763, 6,583,425, and 6,621,086, and PCT Application No. WO 97/03209, the entire disclosures of which are hereby incorporated herein by reference.

There is, therefore, a need for disposable radioactive contamination control articles that sense radiation rays emanating from radioactive contamination and signal the presence of the radiation to the user of the article.

### SUMMARY

Generally, the present invention is directed to a disposable radioactive contamination control article having a sensor that detects ionizing radiation emanating from the contamination and provides a signal indicating the presence of such radioactive contamination; in one case, by detecting the direct interaction of the ionizing radiation with the sensor and/or detecting secondary effects of the interaction of ionizing radiation with the physical constituents of the disposable radioactive contamination control article or adjacent materials. The disposable radioactive contamination control article may be provided in a wide variety of forms including, but not limited to, wipes, smears, filters, coatings, patches, cleaning materials, protective materials, and personnel protective articles or equipment.

In one aspect, the invention relates to a disposable surface wipe article including an ionizing radiation sensor. The sensor is adapted to detect ionizing radiation that is emitted by radioactive contamination that is transferred from a surface to the article in the process of wiping the surface with the article, and to provide a signal to a user of the article indicating the presence of the radioactive contamination on the surface. The signal can be provided within about 24 hours from the time the article contacts the radioactive contamination on the surface. The article can be a cleaning article that incorporates the sensor and is useful for monitoring the progress of cleaning radioactive contamination from a surface. The article can be a wipe or filter smear intended to measure the quantity of radioactive contamination that is removed per unit of surface area by the process of wiping the surface. The article can be a dry wipe or coated with an agent to enhance removal of contamination from a surface or an agent to enhance retention of contamination on the article.

In another aspect, the invention relates to a coating article including an ionizing radiation sensor. The sensor is adapted to detect ionizing radiation that is emitted by radioactive contamination that is on a surface or transferred from the surface to the article in the process of coating the surface or otherwise applying the article to the surface. The sensor provides a signal to a user of the article indicating the presence of the radioactive contamination on the surface. The signal can be provided within about 72 hours from the time the article contacts the radioactive contamination on the surface. The coating may be peelable from a substrate and include an adhesive backing. Alternatively, the coating is not peelable. The coating article may or may not be removable from the object to which it is applied.

In another aspect, the invention relates to a disposable filter article including an ionizing radiation sensor. The sensor is adapted to detect ionizing radiation that is emitted by radioactive contamination that is removed from a fluid, such as a gas or a liquid, and transferred to the article in the process of filtering the fluid. The sensor provides a signal to a user of the article indicating the presence of the radioactive contamination in the fluid. The signal can be provided within about 24 hours from the time the article contacts the radioactive contamination in the fluid. The filter can measure the quantity of radioactive contamination that is removed per unit of fluid volume by the process of filtering the fluid.

In another aspect, the invention relates to a disposable article of personnel protective equipment including an ionizing radiation sensor. The sensor is adapted to detect ionizing radiation that is emitted by radioactive contamination that is transferred to the article as a result of casual contact with surfaces that bear radioactive contamination. The signal can be provided within about 24 hours from the time the article contacts the radioactive contamination on the surface. The article may be used to prevent contamination of equipment, tools, or materials. In addition, personal protective articles can include clothing, shields, eye and ear protective devices, and the like.

In another aspect, the invention relates to a disposable article that can be attached to radioactive contamination control articles. The article including a sensor including an ionizing radiation sensor, where the sensor is configured to detect ionizing radiation that is emitted by radioactive contamination. The sensor can provide a signal to a user of the article indicating the presence of the radioactive contamination on the surface. The signal can be provided within about 24 hours from the time the article contacts the radioactive contamination on the surface.

In various embodiments of the foregoing aspects of the invention, the article can be a hand held article or mounted on a pad, broom, handle, or other fixture. In one example, the article can be operated or attached to a machine or robot. The signal can visible to the naked or unaided eye of a user of the article. Alternatively, the signal provided by the article can be visible to a user equipped with a passive or active viewing device, such as an assisted vision or artificial vision device. In one embodiment, the signal is a calorimetric signal. Further, the signal can be detected with a densitometer or other optical laboratory device, including devices that measure transmitted, reflected, or stimulated photons. A life of the signal may correspond to the useful life of the article. The article can further include a substrate that incorporates the sensor. In one embodiment, the substrate includes a fibrous web. In another embodiment, the substrate is a label than can be affixed to the article.

In further embodiments of the article, the sensor can be configured to detect a flux of X-ray, gamma ray, or energetic beta ray radiation in the location(s) frequented by a person(s) wearing the personnel protective equipment. The article can be configured to be attached or adjacent to an object in order to determine if a flux of X-rays, gamma rays, or beta rays emanates from the object.

These and other objects, along with the advantages and features of the present invention herein disclosed, will become apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIGS. 1A-1C are pictorial representations of various articles in accordance with various embodiments of the invention;

FIG. 2A is an exploded perspective view of an article in accordance with one embodiment of the invention;

FIG. 2B is an exploded perspective view of an article in accordance with an alternative embodiment of the invention;

FIGS. 3A-3F are pictorial representations of various devices incorporating the articles in accordance with various embodiments of the invention; and

FIG. 4 is a pictorial representation of an article in accordance with another embodiment of the invention.

### DETAILED DESCRIPTION

In the following, various embodiments of the present invention are described with reference to a disposable radioactive contamination control article having a sensor that detects ionizing radiation emanating from the contamination and provides a signal indicating the presence of such radioactive contamination. In one embodiment, the sensor detects the direct interaction of the ionizing radiation with the sensor. Alternatively or additionally, the sensor detects secondary effects of the interaction of ionizing radiation with the physical constituents of the disposable radioactive contamination control article or adjacent materials. The sensor being configured for inclusion in the disposable radioactive contamination control materials.

The term “disposable” is used herein to describe articles that generally are not intended to be laundered or otherwise restored or reused as a radioactive contamination control article (i.e. they are intended to be discarded after a single use and, preferably, to be dispositioned to a regulated treatment or disposal facility, as required according to the concentration of radioactive contamination in or on the article). Notwithstanding the above, the articles disclosed herein may be used in conjunction with or attached to reusable radioactive contamination control articles. Examples of such use include, but are not limited to, a disposable wipe attached to a reusable wand or fixture, a disposable mop head attached to a reusable mop apparatus, a disposable sensing patch attached to a reusable coverall or other article of personal protective clothing, a disposable sleeve used to cover a reusable hose or cord, a disposable filter used in a reusable filter housing, a disposable sampling or surveying article incorporated into a sampling apparatus, a disposable removable coating applied to a reusable item of equipment, and similar examples.

The sensors used can be essentially any type of sensor that detects ionizing radiation. Generally, the sensor is a material made from molecules such that the appearance of the light that emanates from or through the material in response to a flux of ionizing radiation is different after exposure to the ionizing radiation. This includes materials that exhibit a step change in appearance and a graduated change in appearance. The molecules may be prepared in a gel suspension, a film, or a fiber. The material may be comprised of molecules such that some constituents interact with ionizing radiation and are directly changed so as to change the appearance of the material. The material may also be manufactured of a mixture of constituents, some that interact more strongly with the ionizing radiation and create intermediate products and subsequently interact with other constituents that cause the appearance of the material to change. The changes include creation of new molecules as well as the polymerization of otherwise unchanged molecules. The sensor molecules can be diacetylene molecules, for example.

The term “disposable radioactive contamination control article” is used herein to describe articles that may be provided in a wide variety of forms including, but not limited to, wipes, smears, filters, coatings, patches, cleaning materials, protective materials, and personnel protective articles or equipment. When used for cleaning purposes, these articles may be used to clean animate surfaces, such as human skin, as well as inanimate surfaces, such as floors, walls, other building or facility surfaces, fixtures, equipment, tools, supplies, or materials.

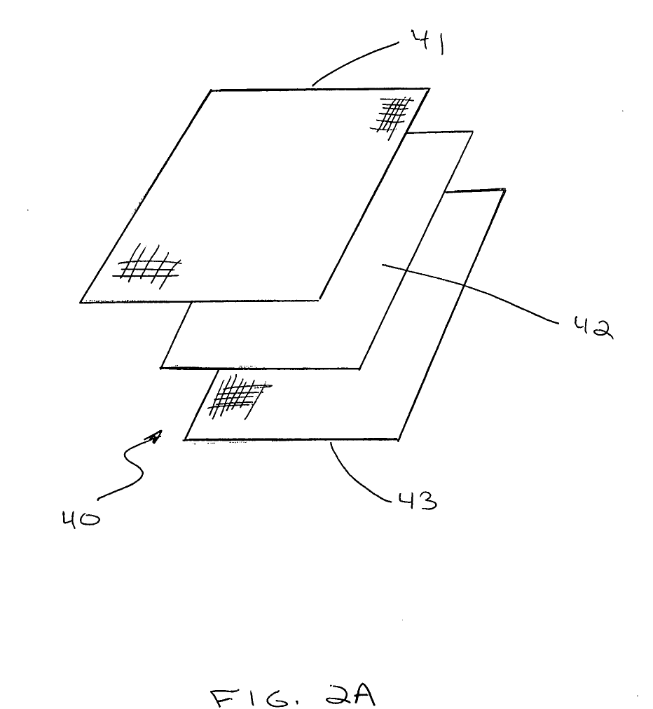

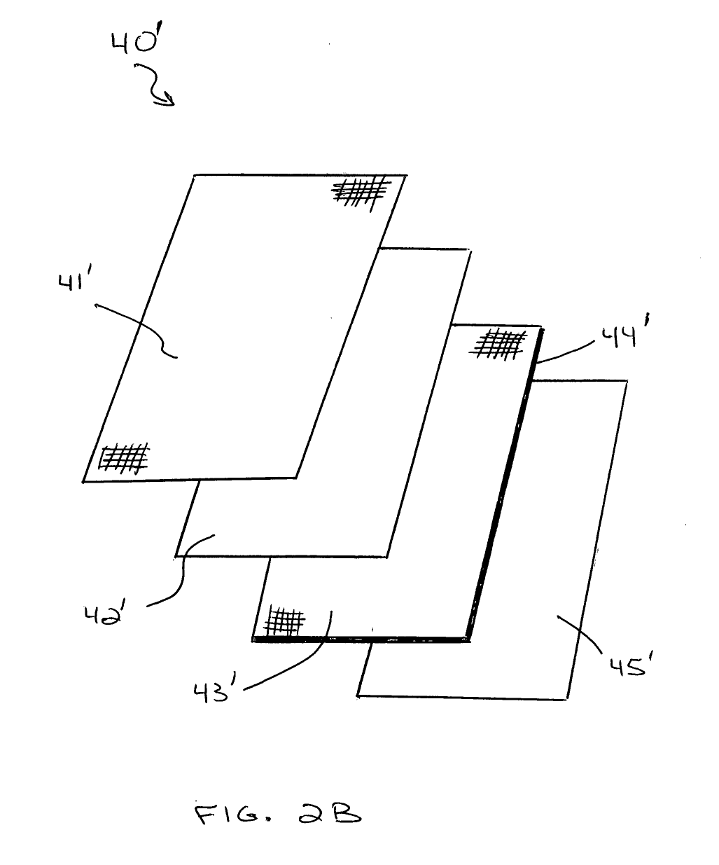

The disposable radioactive contamination control article may be designed or fabricated such that the radiation sensor is integrated into, or attached to, the material, fibers, or fabric of the article. In an alternative embodiment, the articles contain a substrate designed or fabricated such that the radiation sensor is integrated into, or attached to, the material, fibers, or fabric of the article. The article, substrate, or sensor may be a natural or synthetic, woven or non-woven fibrous material, or a non-fibrous material. See, for example, FIGS. 2A and 2B. In one embodiment, the substrate is a loose mesh of sensor fibers that are arranged over a filter. The loose mesh does not affect filtration, but does, for example, change color when exposed to radioactive contamination.

The visible detection of the signal produced by the radiation sensor may be accomplished by observing the unaltered article or by processing or treating the article by means of temperature, radiation, application of chemicals, or other means. In alternative embodiments, the applied chemicals may be solid, gaseous, or liquid and may interact by bonding or catalytic reaction.

In one embodiment, the observation of the signal provided by the radiation sensor is visible to the unaided eye of a user of the article. In an alternative embodiment, the signal provided by the sensor is visible to a user equipped with a passive or active viewing device, which may be an eyeglass or goggle. In one alternative embodiment, a passive viewing device is incorporated into personnel protective (i.e. “safety”) eyeglasses or attached to such eyeglasses.

In yet another embodiment, the disposable radioactive contamination control article is a cleaning article that incorporates the sensor and is useful for monitoring the progress of cleaning radioactive contamination from a surface. For example, the size, shape, or strength of the signal may vary depending on the amount of radioactive contamination to which the article is exposed.

In yet another embodiment, the sensor is incorporated into a coating that is applied to a surface in order to fix radioactive contamination on a surface (see, for example. FIG. 2B). These coatings may be categorized as peelable or non-peelable coatings. Peelable coatings are typically applied to contaminated surfaces in order to decontaminate such surfaces. When cured, the loose radioactive contamination is locked into the surface of the peelable coating and the surface is decontaminated in the process of peeling the coating from the surface. Non-peelable (e.g., non-removable) coatings are applied to contaminated surfaces in order to fix the contamination in place. In the case of peelable or non-peelable coatings, the alternative embodiment involves incorporating the radiation sensor into the coating to allow a user to determine if radioactive contamination exists under or within the coating.

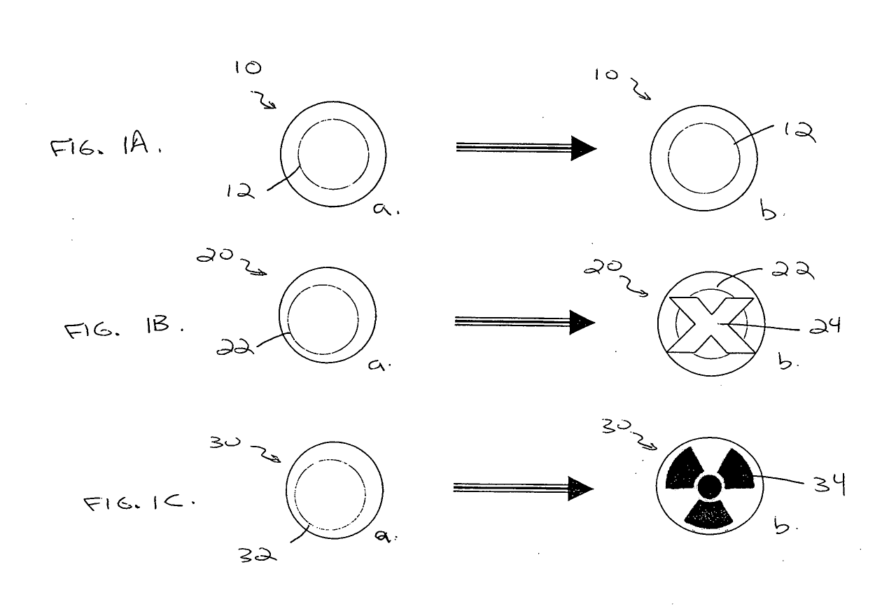

FIGS. 1A-1C depict various articles 10, 20, 30 in accordance with the invention. The articles 10, 20, 30 are depicted in an initial configuration (a.) and a used configuration (b.). The articles 10, 20, 30 include sensors 12, 22, 32 incorporated into the article 10, 20, 30 in accordance with any of the methods described herein. As shown in FIG. 1A, the used article 10 gives no indication (i.e., signal) of exposure to radioactive contamination, which indicates that the article was not exposed to radioactive contamination. Alternatively, the signal may not be visible to the naked eye; therefore, a viewing device may be required to determine if the article 10 was exposed to radioactive contamination.

As shown in FIGS. 1B and 1C, a signal 24, 34 is present on the used article 20, 30, thereby alerting a user to the presence of radioactive contamination. The signal 24, 34 can be text based, symbolic, or combinations thereof. In various embodiments, the signal 24, 34 appears substantially instantaneously or requires a set period of time after being exposed to the radioactive contamination to be activated. In addition, the signal may require manually activation after exposure. The signal can take the form of a color change in the material or a portion of the material of the article. For example, the article may be white in color and a portion of the article (e.g., an X-shape) turns blue when the article is exposed to the radioactive contamination, thereby resulting in a blue signal appearing on a white background of the article. The shade of the signal can vary (e.g., darken) with prolonged or increased exposure to the radioactive contamination.

FIG. 2A depicts a multi-layer article 40 including a first layer 41, a second layer 43, and a sensing layer 42 incorporated therebetween. The sensing layer 42 can be incorporated into the article in accordance with any of the methods described herein and can include any of the types of sensors disclosed herein. The layers 41, 43 can be woven or non-woven, porous or non-porous, and/or can include an adhesive for fixing (permanently or temporarily) the article 40 to an object. Additional layers can be incorporated to suit a particular application. Furthermore, the sensing layer 42 can be substantially co-extensive with the surrounding layers 41, 43 or can be sized and located to selectively sense radioactive contamination. For example, the sensing layer 42 can be disposed in the center of the article 40 or just about the perimeter thereof.

FIG. 2B depicts an alternative multi-layer article 40′ including a first layer 41′, an optional second layer 43′, and a sensing layer 42′. The alternative article 40′ also includes a coating (for example, an adhesive) layer 44′ and a substrate layer 45′ for protecting the coating layer 44′ from the environment prior to use. The substrate layer 45′ can be removed and the coating layer 44′ of the article 40′ applied to a surface or other article. In one embodiment, the sensor layer 42′ and the coating layer 44′ are the same layer, for example, the sensor could be embodied in an adhesive coating.

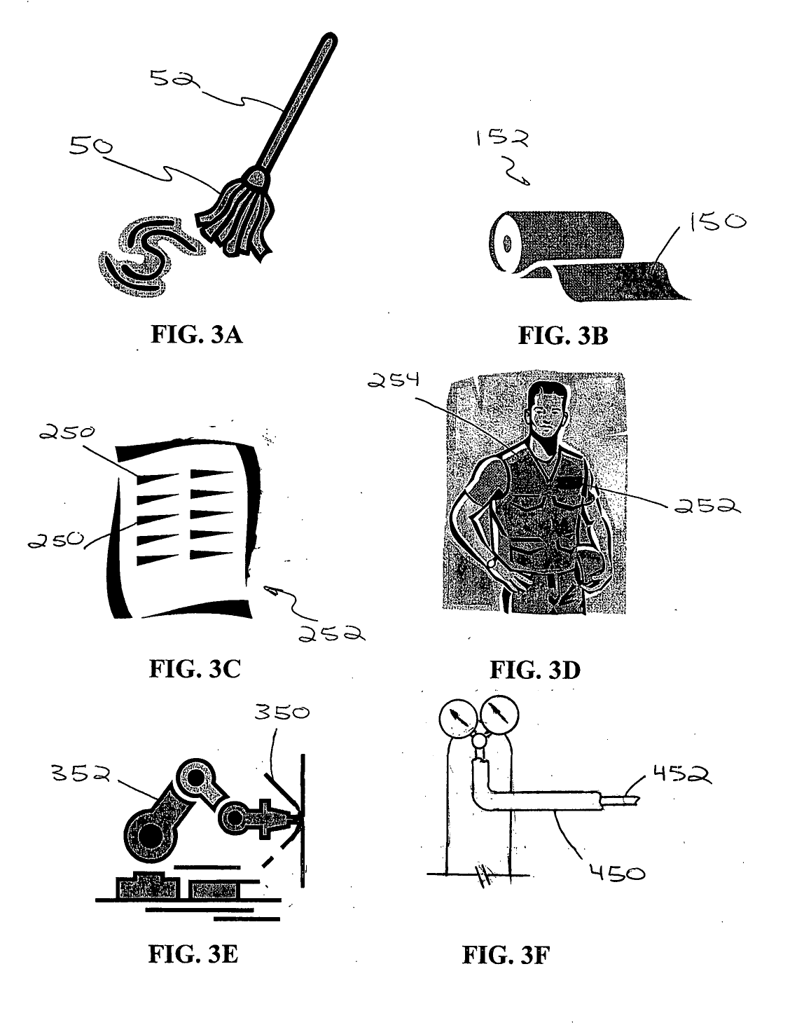

FIGS. 3A-3F depict a variety of objects incorporating articles in accordance with the invention. The list is not exhaustive and is given for illustrative purposes. FIG. 3A depicts an article 50 incorporated onto a pole 52, as may be used with a broom or mop, wand, extension arm, and the like. FIG. 3B depicts a series of articles 150 incorporated into a roll 152, where the individual articles 150 are perforated for easy removal from the roll 152. FIG. 3C depicts a plurality of adhesive backed articles 250 arranged on a substrate 252. The articles 250 can be peeled off of the substrate 252 and applied to an object. For example, as shown in FIG. 3D, the article 250 can be applied to a vest 254 or other type of protective clothing or equipment (e.g., helmet, jumpsuit, shoes, mask). Alternatively, the article 252 can be attached to an object by other mechanical means, including hook and loop type fasteners, such as the Velcro® brand sold by Velcro Industries B.V. Additionally, the protective clothing can incorporate the article in the manufacture thereof, for example by weaving the article directly into the protective clothing, where the entire article, for example a jumpsuit, is disposable.

FIG. 3E depicts an article 350 in accordance with the invention disposed at the end of a robotic arm 352. The robotic arm 352 can be part of a larger portable robotic device or can be fixed in position. The article 350 may be used with a robot in areas where it is undesirable to allow humans to access. FIG. 3F depicts the article 450 as a protective sleeve. The article 450 can be used to prevent the transfer of radioactive material to various objects or to signal if the object has come into contact with radioactive contamination. As shown in FIG. 3F, the article 450 is a protective sleeve disposed over a hose 452.

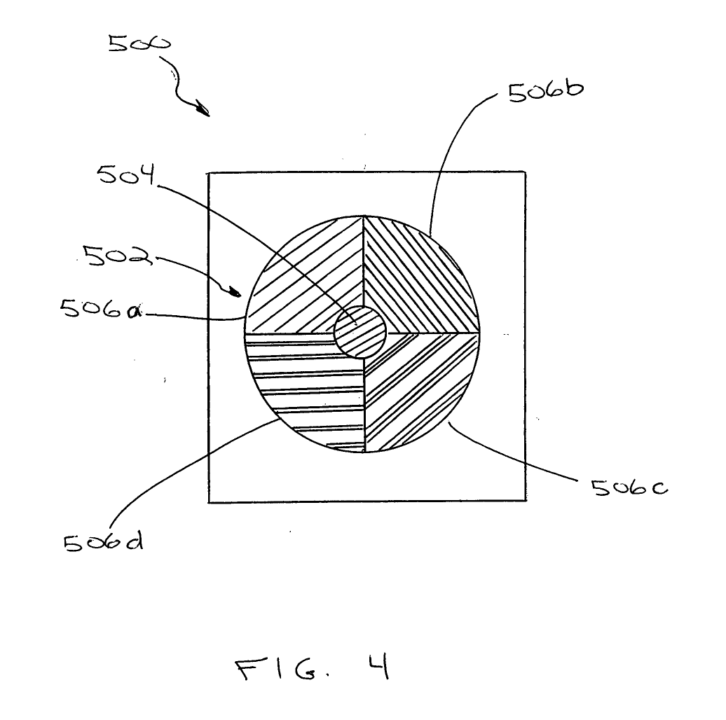

FIG. 4 depicts one embodiment of an article 500 intended to measure and/or indicate the quantity of radioactive contamination that is removed per unit of either surface area cleaned or fluid volume filtered. The quantity measured relates to the amount of radioactive material deposited on or absorbed by the article. The indication of quantity can be based on the changing optical characteristics of the signal. For example, the shade of the signal can darken as the quantity of radiation sensed increases. Alternatively or additionally, the size and/or shape of the signal can change as the quantity of radiation sensed increases. The article 500 includes a legend 502 disposed on the article 500. The sensor can be incorporated into at least a portion of the legend 502, in this case, a center portion 504 of the legend 502.

As shown in FIG. 4, the legend 502 includes a bulls-eye type pattern including the center portion 504 and four quadrants 506a-506d. The legend can be based on 256 shades of a specific color, for example gray, where the center portion 504 has a base shade level of 50 and will darken on exposure to radioactive contamination. The quadrants 506 are colored different shades of gray for comparison to the center portion 504. For example, the first quadrant 506a has a shade level of 50 and serves as a baseline for comparison with the center portion 504. If the center portion 504 is substantially the same shade as the first quadrant 506a, then the article has likely not been exposed to radioactive contamination. The second quadrant 506b can have a shade level of 100. If the center portion 504 matches the second quadrant, the article has been exposed to some level of radioactive contamination. The third quadrant 506c can have a shade of 150, and the fourth quadrant 506d can have a shade level of 200.

Each quadrant's shade level can be correlated to a specific action that needs to be taken when the article has been exposed to a specific quantity of radioactive contamination. For example, a user, by comparing the signal of the center portion 504 with the various quadrants 506a-506d, can be instructed to take a specific action based on which quadrant 506a-506d the center portion 504 most closely matches. Alternatively or additionally, the quadrants 506a-506d, or other indicia, can be correlated to a specific amount of radiation absorbed, such that, for example, a user can tell that the article has absorbed a maximum amount of radiation and a new article is required.

Having described certain embodiments of the invention, it will be apparent to those of ordinary skill in the art that other embodiments incorporating the concepts disclosed herein may be used without departing from the spirit and scope of the invention, as there is a wide variety of further combinations of a heel cup, side walls, tension elements, reinforcing elements and ground surfaces that are possible to suit a particular application and may be included in any particular embodiment of a heel part and shoe sole in accordance with the invention. The described embodiments are to be considered in all respects as only illustrative and not restrictive.

What is claimed is:

1. An article comprising an ionizing radiation sensor, wherein the sensor is configured to detect ionizing radiation that is emitted by radioactive contamination that is transferred from a surface to the article by exposing the article to the surface and to provide an optical signal to a user of the article indicating the presence of the radioactive contamination on the surface.

2. The article of claim 1, wherein the signal is provided within 24 hours from the time the article is exposed to the radioactive contamination on the surface.

3. The article of claim 1, wherein the sensor comprises a calorimetric sensor.

4. The article of claim 1, wherein the article is a disposable surface wipe article exposed to the surface by a process of wiping the surface with the article.

5. The article of claim 4, wherein the article is mountable on at least one of a pad, a broom, a handle, a robotic arm, an extension arm, a wand, and a radioactive contamination control article.

6. The article of claim 4, wherein the surface wipe is a filter smear configured for measuring the quantity of radioactive contamination that is removed per unit of surface area by the process of wiping the surface

7. The article of claim 4, wherein the surface wipe is at least one of a dry wipe and a wipe coated with an agent to enhance at least one of removal of contamination from the surface and retention of contamination on the article.

8. The article of claim 1, wherein the signal is visible to a naked eye.

9. The article of claim 1, wherein the signal is detected by at least one of an assisted vision device, an artificial vision device, and a densitometer.

10. The article of claim 1, wherein the article further comprises a substrate and the sensor is incorporated into the substrate.

11. The article of claim 10, wherein the substrate comprises at least one of a membrane and a fibrous web.

12. The article of claim 1, wherein the article is a coating article exposed to the surface by a process of coating the surface with the article

13. The article of claim 12, wherein the signal is provided within 72 hours from the time the article contacts the radioactive contamination on the surface.

14. The article of claim 12, wherein the coating is a peelable coating.

15. A disposable filter article comprising an ionizing radiation sensor, wherein the sensor is configured to detect ionizing radiation that is emitted by radioactive contamination that is removed from a fluid and transferred to the article in the process of filtering the fluid and to provide a signal to a user of the article indicating the presence of the radioactive contamination in the fluid.

16. The article of claim 15, wherein the article is configured to measure the quantity of radioactive contamination that is removed per unit of fluid volume by the process of filtering the fluid.

17. The article of claim 15, wherein the article further comprises a substrate that incorporates the sensor.

18. The article of claim 17, wherein the substrate comprises a fibrous web.

19. The article of claim 1, wherein the article is a disposable article of protective equipment that is exposed to the ionizing radiation as a result of casual contact with surfaces that bear radioactive contamination.

20. The article of claim 19, wherein the article is used to prevent contamination of at least one of personnel, equipment, tools, and materials.
